(19) United States
(12) Patent Application Publication
(10) Pub. No.: US 2021/0303385 A1
(43) Pub. Date: Sep. 30, 2021

(54) Resource dump system

(71) Applicant: Mellanox Technologies TLV Ltd., Raanana (IL)

(72) Inventors: Ariel Almog, Kohav Yahir (IL); Eyal Davidovich, Maale Adumim (IL); Aviv Shmilovitch, Petah-Tikva (IL)

(21) Appl. No.: 17/152,817

(22) Filed: Jan. 20, 2021

Related U.S. Application Data
(60) Provisional application No. 62/994,871, filed on Mar. 26, 2020.

(51) Int. Cl. G06F 11/07; G06F 11/30; G06F 11/32

(52) U.S. Cl. CPC G06F 11/0778; G06F 11/328; G06F 11/3037; G06F 11/0775

(57) ABSTRACT

In one embodiment, a processing device includes a memory, and configured to provide a data dump of the memory, a storage element configured to store a dictionary including interpreter vocabulary to interpret at least some segments of the data dump, and a data dump analysis device including an interface configured to transfer data with the processing device, a dump extraction engine configured to connect with the processing device over the interface, and receive at least one segment of the data dump from the processing device over the interface, and a dump interpretation engine configured to receive at least a subset of the interpreter vocabulary from the dictionary to interpret the received at least one segment, and interpret data of the at least one segment responsively to the received at least subset of the interpreter vocabulary.

### RELATED APPLICATION INFORMATION

The present application claims benefit of U.S. Provisional Patent Application Ser. 62/994,871 of Almog, et al., filed 26 Mar. 2020, the disclosure of which is hereby incorporated herein by reference.

### FIELD OF THE INVENTION

The present invention relates to computer system, and in particular, but not exclusively to, resource dumps.

### BACKGROUND

When a processing device (for example, a switch, router, network interface controller (NIC)) encounters some kind of issue or problem, internal information (e.g., of a memory dump or other resource dump) is generally retrieved from the processing device and analyzed to determine what caused the issue or problem.

### SUMMARY

There is provided in accordance with an embodiment of the present disclosure, a system, including a processing device including a memory, and configured to provide a data dump of the memory, a storage element configured to store a dictionary including interpreter vocabulary to interpret at least some segments of the data dump, and a data dump analysis device including an interface configured to transfer data with the processing device, a dump extraction engine configured to connect with the processing device over the interface, and receive at least one segment of the data dump from the processing device over the interface, and a dump interpretation engine configured to receive at least a subset of the interpreter vocabulary from the dictionary to interpret the received at least one segment, and interpret data of the at least one segment responsively to the received at least subset of the interpreter vocabulary.

Further in accordance with an embodiment of the present disclosure, the system includes a display, and a user interface, which is configured to render the interpreted data to the display.

Still further in accordance with an embodiment of the present disclosure, the system includes a remote processing device including the storage element and configured to maintain the dictionary.

Additionally, in accordance with an embodiment of the present disclosure the remote processing device is configured to supply only a part of the interpreter vocabulary to the data dump analysis device.

Moreover, in accordance with an embodiment of the present disclosure the interpreter vocabulary includes respective different sections for use in interpreting data dumps of respective different processing devices.

Further in accordance with an embodiment of the present disclosure, the system includes a display, wherein the data dump analysis device includes a user interface configured to receive a user request to retrieve the at least one segment of the data dump, issue a command to the dump extraction engine to request the at least one segment of the data dump from the processing device, receive the interpreted data from the dump interpretation engine and a list of references to sub-segments of the at least one segment of the data dump from the dump extraction engine, and render the interpreted data and the list of references to the display.

Still further in accordance with an embodiment of the present disclosure, the system includes a display, wherein the data dump analysis device includes a user interface configured to receive a user request to retrieve the at least one segment and sub-segments of the at least one segment, and issue a command to the dump extraction engine to request the at least one segment and the sub-segments of the data dump from the processing device, and the dump extraction engine is configured to receive the at least one segment of the data dump and a list of references to the sub-segments from the processing device, request the sub-segments from the processing device responsively to the received list of references to the sub-segments, and receive the sub-segments.

Additionally, in accordance with an embodiment of the present disclosure the dump interpretation engine is configured to receive another subset of the interpreter vocabulary from the dictionary to interpret the received sub-segments, and interpret data of the sub-segments responsively to the received other subset of the interpreter vocabulary, and the user interface is configured to render the interpreted data of the at least one segment and the interpreted data of the sub-segments to the display.

Moreover, in accordance with an embodiment of the present disclosure the processing device is configured to add a new segment to the data dump, the system further including a controller configured to add new interpreter vocabulary to the dictionary to interpret the new segment of the data dump.

Further in accordance with an embodiment of the present disclosure the dump interpretation engine is configured to provide the interpreted data in at least one of a machine-readable form, or a human-readable form.

There is also provided in accordance with another embodiment of the present disclosure, a data dump method, including providing a data dump of a memory, storing a dictionary including interpreter vocabulary to interpret at least some segments of the data dump, receiving at least one segment of the data dump, receiving at least a subset of the interpreter vocabulary from the dictionary, and interpreting data of the at least one segment responsively to the received at least subset of the interpreter vocabulary.

Still further in accordance with an embodiment of the present disclosure, the method includes rendering the interpreted data to a display.

Additionally, in accordance with an embodiment of the present disclosure the interpreter vocabulary includes respective different sections for use in interpreting data dumps of respective different processing devices.

Moreover, in accordance with an embodiment of the present disclosure, the method includes receiving a user request to retrieve the at least one segment of the data dump, issuing a command to request the at least one segment of the data dump, receiving the interpreted data and a list of references to sub-segments of the at least one segment of the data dump, and rendering the interpreted data and the list of references to the display.

Further in accordance with an embodiment of the present disclosure, the method includes receiving a user request to retrieve the at least one segment and sub-segments of the at least one segment, issuing a command to request the at least one segment and the sub-segments of the data dump, receiving the at least one segment of the data dump and a list of references to the sub-segments, requesting the sub-segments responsively to the received list of references to the sub-segments, and receiving the sub-segments.

Still further in accordance with an embodiment of the present disclosure, the method includes receiving another subset of the interpreter vocabulary from the dictionary to interpret the received sub-segments, interpreting data of the sub-segments responsively to the received other subset of the interpreter vocabulary, and rendering the interpreted data of the at least one segment and the interpreted data of the sub-segments to a display.

Additionally, in accordance with an embodiment of the present disclosure, the method includes adding a new segment to the data dump, and adding new interpreter vocabulary to the dictionary to interpret the new segment of the data dump.

Moreover, in accordance with an embodiment of the present disclosure, the method includes providing the interpreted data in at least one of a machine-readable form, or a human-readable form.

There is also provided in accordance with still another embodiment of the present disclosure a software product, including a non-transient computer-readable medium in which program instructions are stored, which instructions, when read by a central processing unit (CPU), cause the CPU to store a dictionary including interpreter vocabulary to interpret at least some segments of a data dump of a memory, receive at least one segment of the data dump, receive at least a subset of the interpreter vocabulary from the dictionary, and interpret data of the at least one segment responsively to the received at least subset of the interpreter vocabulary.

There is also provided in accordance with still another embodiment of the present disclosure a data dump method, including providing a data dump of a memory, receiving at least part of the data dump, receiving interpreter vocabulary from a dictionary, and interpreting data of the at least part of the data dump based on the interpreter vocabulary.

### BRIEF DESCRIPTION OF THE DRAWINGS

The present invention will be understood from the following detailed description, taken in conjunction with the drawings in which:

FIG. 1 is a block diagram view of a resource dump system constructed and operative in accordance with an embodiment of the present invention;

FIG. 2 is a flowchart including steps in a method of operation of a user interface of the system of FIG. 1;

FIG. 3 is a flowchart including steps in a method of operation of a dump extraction engine of the system of FIG. 1;

FIG. 4 is a flowchart including steps in a method of operation of a dump interpretation engine of the system of FIG. 1;

FIG. 5 is a flowchart including steps in a method of operation of a user interface of the system of FIG. 1; and

FIG. 6 is a flowchart including steps in a method of operation of a dump extraction engine of the system of FIG. 1.

### DESCRIPTION OF EXAMPLE EMBODIMENTS

### Overview

Data dumps may vary from device to device and in general do not have a standard interface. One solution is to process the dumped data in a dump analysis tool, which receives the dump data, optionally parses the data, and interprets the data. For example, a device may provide a data dump as a binary string (i.e., zeros and ones), which may give the status of various flags or queues and the content of different registers or part (or all) of device memory. The dump analysis tool may be programmed to interpret the dumped data so that the interpreted data may be machine or human readable. For example, the binary string may be interpreted as flag A having a value of 2, flag B having a value of 5, queue Z having a length of 14, and so on. The interpreted data may than be used to find a problem or issue with the processing device so that action may be taken to fix the problem or issue and/or prevent the problem or issue from reoccurring.

The above solution does not provide flexibility if the dump format provided by the device is changed or if additional dump data needs to be added to the dump. In such cases, the dump analysis tool will require updating, testing, approval, and redistribution.

Embodiments of the present invention solve the above problems by providing a dictionary which includes interpreter vocabulary used to interpret segments of a data dump. A data dump analysis device receives one or more segments of the data dump from a processing device and interprets the received segment(s) using corresponding interpreter vocabulary retrieved from the dictionary. In this manner, if the structure of the data dump is changed, the interpreter vocabulary may be changed to enable the data dump analysis device to interpret the updated data dump without changing the configuration (e.g., programming and/or wiring) of the data analysis device.

The data dump analysis device may interpret data dumps of multiple processing devices including different types of processing devices having corresponding different data dump structures. In these embodiments, the dictionary includes interpreter vocabulary to interpret the data dumps provided by the various processing devices.

In some embodiments, the dictionary is stored remotely to the data dump analysis device and optionally only part of the dictionary is supplied to the data dump analysis device. For example, if the data dump analysis device runs an on-site tool available to a network administrator who analyses data dumps from network devices such as switches, a subset of the dictionary may be made available to the data dump analysis device so that the network administrator has visibility to a subset of issues associated with the switches, while the full version of the dictionary may be made available to the switch manufacturer to analyze the devices fully. In other embodiments, the dictionary is stored locally to the data dump analysis device. In some embodiments, a copy of the dictionary or a subset of the dictionary is also stored locally to the data dump analysis device.

The data dump analysis device may include a user interface through which a user may request a menu including a list of the various segments of the data dump available for retrieval. Based on the menu, which is rendered by the user interface to a display, the user may then request one or more segments and optionally sub-segments of the requested segment(s) from the data dump via the user interface. The sub-segments may be retrieved based on links between sub-segments and associated segments stored in the processing device. For example, the data dump analysis device receives a list of reference to the sub-segments and then requests the sub-segments from the processing device. The received segment(s) and sub-segments are interpreted by the data dump analysis device responsively to interpreter vocabulary from the dictionary. The interpreted data is then rendered to the display by the user interface.

If the sub-segments are not requested by the user, but exist in the data dump, the processing device may return a list of references to the sub-segments for rendering to the display device by the user interface. The user may then manually request one or more of the sub-segments from the data dump via the user interface.

The menu is also dynamic and may be updated without changing the configuration of the data dump analysis device. In some embodiments, the menu data stored in the processing device may be updated as necessary, for example, responsively to adding new segments to the data dump.

### System Description

Documents incorporated by reference herein are to be considered an integral part of the application except that, to the extent that any terms are defined in these incorporated documents in a manner that conflicts with definitions made explicitly or implicitly in the present specification, only the definitions in the present specification should be considered.

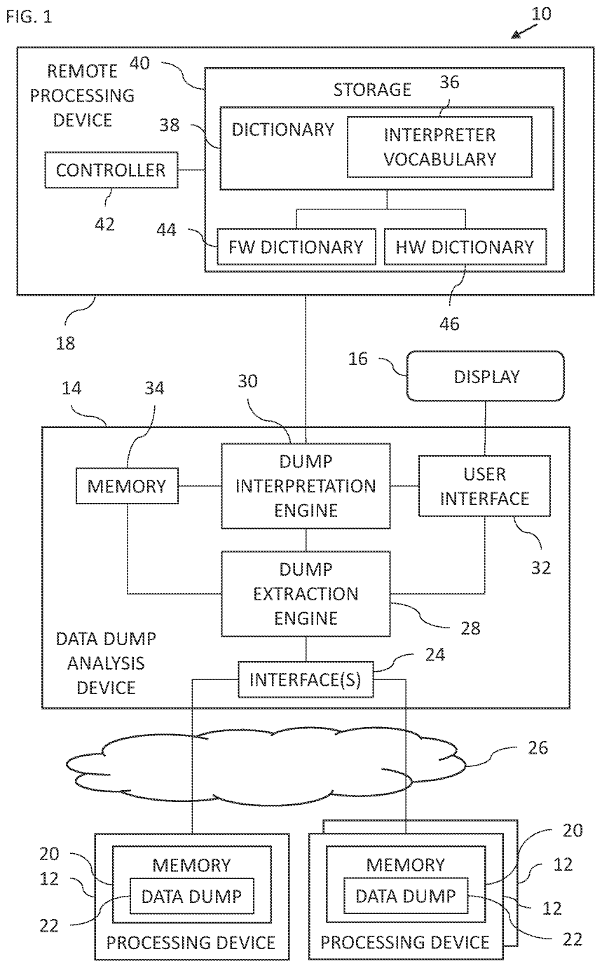

Reference is now made to FIG. 1, which is a block diagram view of a resource dump system 10 constructed and operative in accordance with an embodiment of the present invention. The resource dump system 10 includes processing devices 12, a data dump analysis device 14, an optional display 16, and a remote processing device 18.

Each processing device 12 comprises a memory 20, and is configured to provide a data dump 22 of the respective memory 20 of that processing device 12. The memory 20 may comprise one or more sub-memories, for example, registers, non-volatile and/or volatile memory. The processing devices 12 may be the same type of processing device providing a data dump with the same structure, or different types of processing devices providing data dumps with different structures. In some embodiments, the resource dump system 10 may include multiple data dump analysis devices 14 to analyze data dumps of different client installations (each installation may include multiple processing devices 12).

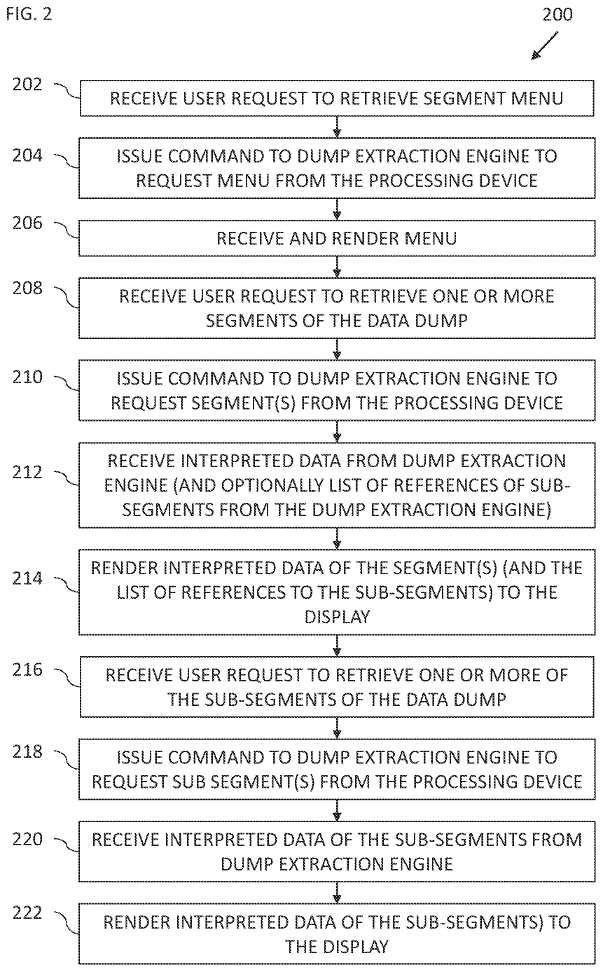

The data dump analysis device 14 includes at least one interface 24 configured to transfer data with the processing devices 12 over a suitable connection, for example, over a peripheral bus connection and/or over a (wired and/or wireless) network 26. In some embodiments, the resource dump system 10 and/or the data dump analysis device 14 may be cloud based. The data dump analysis device 14 also includes a dump extraction engine 28, a dump interpretation engine 30, a user interface 32, and a memory 34. The dump extraction engine 28 extracts one or more segments of the data dump 22 from one of the processing devices 12 optionally responsively to a request, e.g., a user request via the user interface 32. The extracted segment or segments are provided to the dump interpretation engine 30, which (optionally parses and) interprets the segment(s) responsively to a subset (or all) of interpreter vocabulary 36 of a dictionary 38, described in more detail below. The user interface 32 is configured to render the interpreted segment(s) on the display 16, by way of example. The memory 34 is configured to store data used by the dump extraction engine 28, dump interpretation engine 30, and user interface 32. For example, the memory 34 may store part, or all, of the dictionary 38. The elements of the data dump analysis device 14 are described in more detail with reference to FIGS. 2-6.

In practice, some or all of these functions of the dump extraction engine 28, dump interpretation engine 30, user interface 32 may be combined in a single physical component or, alternatively, implemented using multiple physical components. These physical components may comprise hard-wired or programmable devices, or a combination of the two. In some embodiments, at least some of the functions of the dump extraction engine 28, dump interpretation engine 30, user interface 32 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The remote processing device 18 includes a storage element 40, and a controller 42. The controller 42 of the remote processing device 18 is configured to maintain the dictionary 38 and store the dictionary 38 in the storage element 40. In some embodiments, the remote processing device 18 is configured to supply only a part of the interpreter vocabulary 36 to the data dump analysis device 14. In some embodiments, the controller 42 is configured to form the dictionary 38 from a firmware (FW) dictionary 44 used to interpret FW data dumps and a hardware (HW) dictionary 46 used to interpret HW data dumps.

The interpreter vocabulary 36 may include respective different sections for use in interpreting (and optionally parsing) data dumps of respective different processing devices 12. Each section of the interpreter vocabulary 36 may include sub-sections to interpret different segments and sub-segments of a data dump of a respective one of the processing devices 12. For example, section A of the interpreter vocabulary 36 may be used to interpret the data dump of a processing device A, while section B of the interpreter vocabulary 36 may be used to interpret the data dump of a processing device B, and so on. The section A of the interpreter vocabulary 36 may include sub-sections A1, A2, A3 etc. to interpret segments 1, 2, 3 of the data dump of processing device A, and so on.

Any of the processing devices 12 may be configured to add a new segment or segments to its data dump 22. Corresponding to the addition of a segment or segments to one of the data dumps 22, the controller 42 is configured to add new interpreter vocabulary to the dictionary 38 to interpret the new segment(s) of the data dump 22.

In some embodiments, the processing device 18 is implemented as a device which is in the same network as the data dump analysis device 14. In some embodiments, the processing device 18 and the data dump analysis device 14 are implemented as a single device.

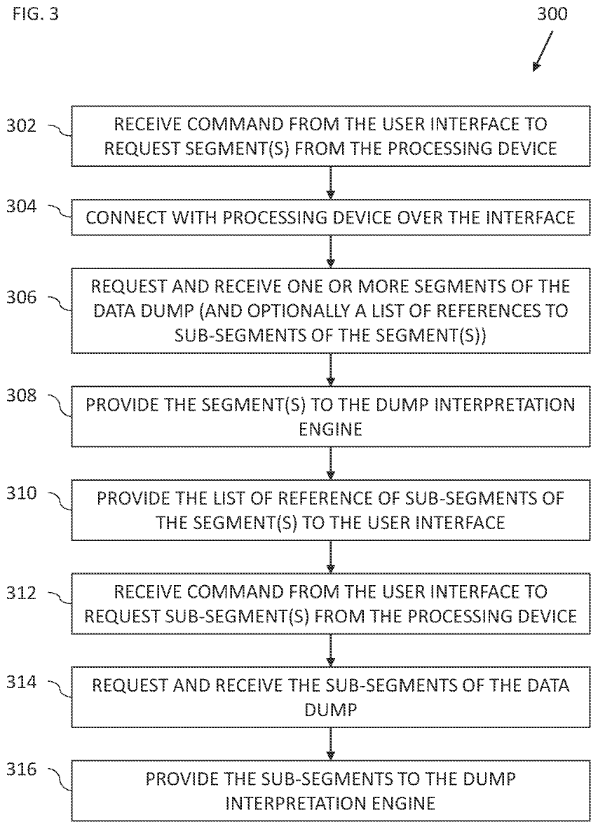

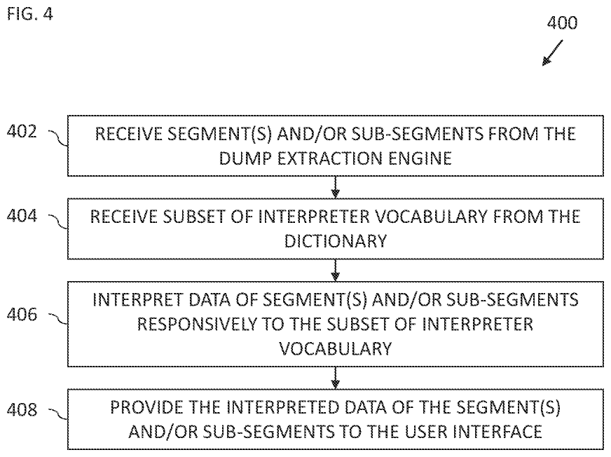

Reference is now made to FIGS. 2-4. FIG. 2 is a flowchart 200 including steps in a method of operation of the user interface 32 of the system 10 of FIG. 1. FIG. 3 is a flowchart 300 including steps in a method of operation of the dump extraction engine 28 of the system 10 of FIG. 1. FIG. 4 is a flowchart 400 including steps in a method of operation of the dump interpretation engine 30 of the system 10 of FIG. 1.

The user interface 32 is configured to receive (block 202) a user request to retrieve a segment menu from one of the processing devices 12. The segment menu may include a list of segments (and optionally sub-segments) and segment descriptions of the data dump 22 of that processing device 12. Different processing devices 12 may include different segment menus. The user interface 32 is configured to issue (block 204) a command to the dump extraction engine 28 to request the segment menu from that processing device 12. The dump extraction engine 28 is configured to request and receive the segment menu from that processing device 12 and provide the received segment menu to the user interface 32. The user interface 32 is configured to receive the segment menu and render (block 206) the received segment menu to the display 16.

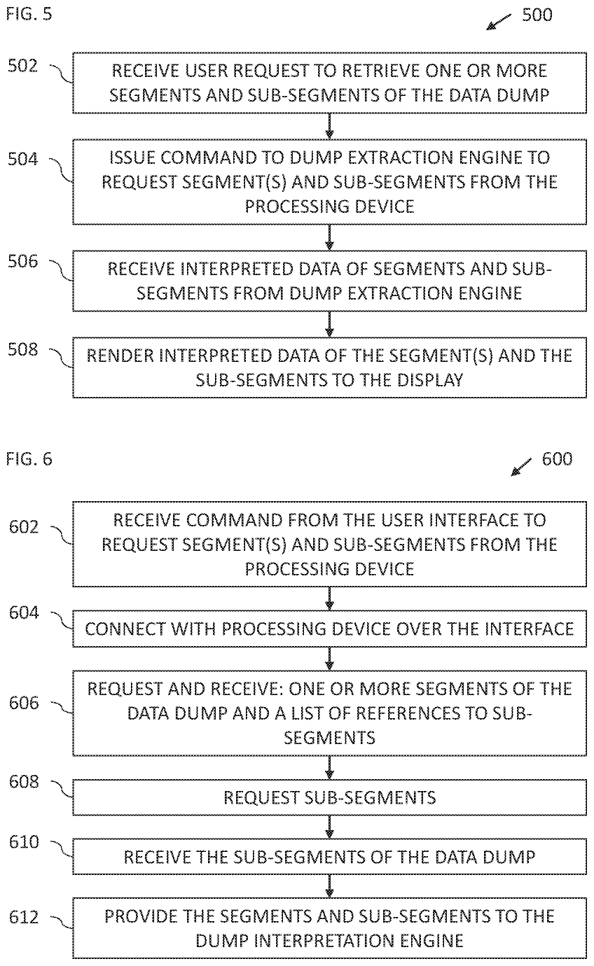

The user interface 32 is configured to: receive (block 208) a user request to retrieve one or more segments of the data dump 12 of one of the processing devices 12; and issue (block 210) a command to the dump extraction engine 28 to request the requested segment(s) of the data dump 12 from the relevant processing device 12. The user interface 32 may also provide the user an option to request a list of sub-segments of the requested segment(s). In some embodiments, the user may request to automatically receive sub-segments of the requested segment or segments with the requested segments, as described in more detail with reference to FIGS. 5-6.

The dump extraction engine 28 is configured to receive (block 302) the command from the user interface 32 to request one or more segments of the data dump 22 from the relevant processing device 12. The dump extraction engine 28 is configured to: connect (block 304) with the relevant processing device 12 over the interface 24; and request (block 306) the segment(s) of the data dump 22 from the relevant processing device 12 over the interface 24. The dump extraction engine 28 may be optionally configured to request a list of references to sub-segments of the requested segments. The dump extraction engine 28 may be configured to request and receive the data from the processing devices 12 via any suitable communication protocol, for example, PCIe configuration space, verbs, DevX, MSTDriver, CMD.

The relevant processing device 12 concatenates metadata of the requested segment(s) of the data dump 22 to an output buffer of that processing device 12, followed by the segment(s) of the data dump 22. If the size of a segment is smaller than the output buffer, then spare information is removed from the segment. The metadata may include information such as the length of the data of the segment(s) and the segment identification. The segment(s) of the data dump 22 may be followed by a termination or error notice. Other data such as the list of references to sub-segments and the menu may concatenated to the output buffer sandwiched between metadata about the list of references sub-segments or the menu and a termination or error notice.

The dump extraction engine 28 is configured to receive (block 306) the segment(s) of the data dump 22 from the relevant processing device 12 over the interface 24. The dump extraction engine 28 may be optionally configured to receive the list of references to sub-segments of the requested segments. The dump extraction engine 28 is configured to provide (block 308) the segment(s) to the dump interpretation engine 30 and optionally provide (block 310) the list of reference to the sub-segments to the user interface 32.

The dump interpretation engine 30 is configured to receive (block 402) the segment(s) (and/or sub-segments if requested) from the dump extraction engine 28. The dump interpretation engine 30 is configured to: receive (block 404) a subset of the interpreter vocabulary 36 (needed to interpret the received segment(s) and/or sub-segments) from the dictionary 38 to interpret the received segment(s) and/or sub-segments; and interpret (and optionally parse) (block 406) data of the received segment(s) and/or sub-segments responsively to the received subset of the interpreter vocabulary 36. The dump interpretation engine 30 is configured to provide (block 408) the interpreted data of the segment(s) and/or sub-segments to the user interface 32. The dump interpretation engine 30 is configured to provide the interpreted data in a machine-readable form (for example, for debugging software) and/or in a human-readable form (for example, to be rendered on the display 16).

The user interface 32 is configured to: receive (block 212) the interpreted data from the dump interpretation engine 30, and optionally the list of references to the sub-segments of the requested segment(s) of the data dump 22 from the dump extraction engine 28; and render (block 214) the interpreted data and the list of references to the display 16.

The user may request sub-segments from the displayed list of references. The user interface 32 is configured to: receive (block 216) a user request to retrieve sub-segment(s) of the data dump 22: and issue (block 218) a command to the dump extraction engine 28 to request the requested sub-segment(s) of the data dump 12 from the relevant processing device 12.

The dump extraction engine 28 is configured to receive (block 312) the command from the user interface 32 to request the sub-segment(s) of the data dump 22 from the relevant processing device 12. The dump extraction engine 28 is configured to: connect with the relevant processing device 12 over the interface 24; and request and receive (block 314) the requested sub-segment(s) of the data dump 22 from the relevant processing device 12 over the interface 24. The dump extraction engine 28 is configured to provide (block 316) the sub-segment(s) to the dump interpretation engine 30. The dump interpretation engine 30 is configured to process the provided sub-segments according to the steps of blocks 402-408, described above.

The user interface 32 is configured to: receive (block 220) the interpreted data of the sub-segments from the dump interpretation engine 30; and render (block 222) the interpreted data of the sub-segments to the display 16.

Reference is now made to FIGS. 5 and 6. FIG. 5 is a flowchart 500 including steps in a method of operation of the user interface 32 of the system 10 of FIG. 1. FIG. 6 is a flowchart 600 including steps in a method of operation of the dump extraction engine 28 of the system 10 of FIG. 1.

The user interface 32 is configured to: receive (block 502) a user request to retrieve one or more segments and sub-segments of the requested segment(s) of the data dump 22 of one of the processing devices 12; and issue (block 504) a command to the dump extraction engine 28 to request the user requested segment(s) and sub-segments of the user requested segment(s) of the data dump 22 from the relevant processing device 12.

The dump extraction engine 28 is configured to receive (block 602) the command from the user interface 32 to request the requested segment(s) and sub-segments of the requested segment(s) of the data dump 22 from the relevant processing device 12. The dump extraction engine 28 is configured to: connect (block 604) with the relevant processing device 12 over the interface 24; and request and receive (block 606) the segment(s) of the data dump 22 and a list of references to the sub-segments of the requested segments from the relevant processing device 12 over the interface 24.

The dump extraction engine 28 is configured to request (block 608) the sub-segments from the relevant processing device 12 responsively to the received list of references to the sub-segments. The dump extraction engine 28 is configured to receive (block 610) the requested sub-segments of the data dump 22. The dump extraction engine 28 is configured to provide (block 612) the received segment(s) and sub-segments to the dump interpretation engine 30.

The dump interpretation engine 30 is configured to process the segment(s) and the sub-segments in accordance with the steps of blocks 402-408 as described above. In particular, the dump interpretation engine 30 is configured to: receive another subset of the interpreter vocabulary 36 from the dictionary 38 to interpret the received sub-segments; and interpret data of the sub-segments responsively to the received other subset of the interpreter vocabulary 36.

The user interface 32 is configured to: receive (block 506) the interpreted data of the segments and sub-segments from the dump interpretation engine 30; and render the interpreted data of the segment(s) and sub-segments to the display 16.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising:
a processing device comprising a memory, and configured to provide a data dump of the memory;
a storage element configured to store a dictionary comprising interpreter vocabulary to interpret at least some segments of the data dump; and
a data dump analysis device comprising:
an interface configured to transfer data with the processing device;
a dump extraction engine configured to: connect with the processing device over the interface; and receive at least one segment of the data dump from the processing device over the interface; and
a dump interpretation engine configured to: receive at least a subset of the interpreter vocabulary from the dictionary to interpret the received at least one segment; and interpret data of the at least one segment responsively to the received at least subset of the interpreter vocabulary.

2. The system according to claim 1, further comprising: a display; and a user interface, which is configured to render the interpreted data to the display.

3. The system according to claim 1, further comprising a remote processing device comprising the storage element and configured to maintain the dictionary.

4. The system according to claim 3, wherein the remote processing device is configured to supply only a part of the interpreter vocabulary to the data dump analysis device.

5. The system according to claim 1, wherein the interpreter vocabulary comprises respective different sections for use in interpreting data dumps of respective different processing devices.

6. The system according to claim 1, further comprising a display, wherein the data dump analysis device comprises a user interface configured to: receive a user request to retrieve the at least one segment of the data dump; issue a command to the dump extraction engine to request the at least one segment of the data dump from the processing device; receive the interpreted data from the dump interpretation engine and a list of references to sub-segments of the at least one segment of the data dump from the dump extraction engine; and render the interpreted data and the list of references to the display.

7. The system according to claim 1, further comprising a display, wherein:
the data dump analysis device comprises a user interface configured to:
receive a user request to retrieve the at least one segment and sub-segments of the at least one segment; and
issue a command to the dump extraction engine to request the at least one segment and the sub-segments of the data dump from the processing device; and
the dump extraction engine is configured to:
receive the at least one segment of the data dump and a list of references to the sub-segments from the processing device;
request the sub-segments from the processing device responsively to the received list of references to the sub-segments; and
receive the sub-segments.

8. The system according to claim 7, wherein:
the dump interpretation engine is configured to:
receive another subset of the interpreter vocabulary from the dictionary to interpret the received sub-segments; and
interpret data of the sub-segments responsively to the received other subset of the interpreter vocabulary; and
the user interface is configured to render the interpreted data of the at least one segment and the interpreted data of the sub-segments to the display.

9. The system according to claim 1, wherein the processing device is configured to add a new segment to the data dump, the system further comprising a controller configured to add new interpreter vocabulary to the dictionary to interpret the new segment of the data dump.

10. The system according to claim 1, wherein the dump interpretation engine is configured to provide the interpreted data in at least one of: a machine-readable form; or a human-readable form.

11. A data dump method, comprising:
providing a data dump of a memory;
storing a dictionary comprising interpreter vocabulary to interpret at least some segments of the data dump;
receiving at least one segment of the data dump;
receiving at least a subset of the interpreter vocabulary from the dictionary; and
interpreting data of the at least one segment responsively to the received at least subset of the interpreter vocabulary.

12. The method according to claim 11, further comprising rendering the interpreted data to a display.

13. The method according to claim 11, wherein the interpreter vocabulary comprises respective different sections for use in interpreting data dumps of respective different processing devices.

14. The method according to claim 11, further comprising:
receiving a user request to retrieve the at least one segment of the data dump;
issuing a command to request the at least one segment of the data dump;
receiving the interpreted data and a list of references to sub-segments of the at least one segment of the data dump; and
rendering the interpreted data and the list of references to the display.

15. The method according to claim 11, further comprising:
receiving a user request to retrieve the at least one segment and sub-segments of the at least one segment;
issuing a command to request the at least one segment and the sub-segments of the data dump;
receiving the at least one segment of the data dump and a list of references to the sub-segments;
requesting the sub-segments responsively to the received list of references to the sub-segments; and
receiving the sub-segments.

16. The method according to claim 15, further comprising:
receiving another subset of the interpreter vocabulary from the dictionary to interpret the received sub-segments;
interpreting data of the sub-segments responsively to the received other subset of the interpreter vocabulary; and
rendering the interpreted data of the at least one segment and the interpreted data of the sub-segments to a display.

17. The method according to claim 11, further comprising:
adding a new segment to the data dump; and
adding new interpreter vocabulary to the dictionary to interpret the new segment of the data dump.

18. The method according to claim 11, further comprising providing the interpreted data in at least one of: a machine-readable form; or a human-readable form.

19. A software product, comprising a non-transient computer-readable medium in which program instructions are stored, which instructions, when read by a central processing unit (CPU), cause the CPU to:
store a dictionary comprising interpreter vocabulary to interpret at least some segments of a data dump of a memory;
receive at least one segment of the data dump;
receive at least a subset of the interpreter vocabulary from the dictionary; and
interpret data of the at least one segment responsively to the received at least subset of the interpreter vocabulary.

20. A data dump method, comprising:
providing a data dump of a memory;
receiving at least part of the data dump;
receiving interpreter vocabulary from a dictionary; and
interpreting data of the at least part of the data dump based on the interpreter vocabulary.
